(19) United States
(12) Patent Application Publication
(10) Pub. No.: US 2024/0050890 A1
(43) Pub. Date: Feb. 15, 2024

(54) METHOD FOR CAPTURING A MOLECULE OF INTEREST AND ASSOCIATED CAPTURE SYSTEM

(71) Applicant: TOTALENERGIES ONETECH, Courbevoie (FR)

(72) Inventors: Jacques Bousquet, IRIGNY (FR); Rayane Hoballah, Pau (FR); Michel Meyer, Pau (FR); Benoit Mizzi, Pau (FR); David Rouzineau, Pau (FR)

(21) Appl. No.: 18/269,629

(22) PCT Filed: Dec. 24, 2020
(86) PCT No.: PCT/FR2020/052626

§ 371 Date: Jun. 26, 2023

(51) Int. Cl. B01D 53/14; B01D 53/18; B01D 53/62; B01D 53/78; B01D 53/96; C01B 32/50

(52) U.S. Cl. CPC B01D 53/1425; B01D 53/1475; B01D 53/18; B01D 53/1493; B01D 53/62; B01D 53/78; B01D 53/96; C01B 32/50; B01D 2252/103; B01D 2252/504; B01D 2252/102; B01D 2252/20447; B01D 2251/306; B01D 2251/606; B01D 2252/60

(57) ABSTRACT

The invention relates to a system or method for capturing a molecule of interest contained in an industrial gaseous effluent, enabling the implementation of a regeneration step (120) in at least one regeneration section (30), a condensation step (150) in at least one condensation section (40), and wherein a step (130) of compressing the gas mixture comprising a solvent and the molecule of interest upstream of the condensation section (40) so that the pressure in the at least one condensation section (40) is at least three times higher than the pressure in the at least one regeneration section (30). The method further comprises a heat transfer step (140) between the at least one condensation section (40) and the at least one regeneration section (30).

The invention concerns a method for capturing a molecule of interest contained in a gaseous effluent, preferably in an industrial gaseous effluent, said method especially implementing a step for capturing a molecule of interest by a chemical absorbent and a step for regenerating the chemical absorbent loaded with the molecule of interest. The invention also concerns a system for capturing a molecule of interest contained in a gaseous effluent, said system for capturing a molecule of interest comprising at least one absorption column for capturing a molecule of interest by a chemical absorbent and a regeneration column. The invention can be applied to industrial gaseous effluents as well as to native gaseous effluents such as natural gas.

### PRIOR ART

Carbon dioxide is considered to be responsible for 60% of global warming caused by greenhouse gases or ‘GHGs’ (according to data published by the Commissariat général du développement durable [Commissioner-General for Sustainable Development] in ‘Chiffres clés du climat France, Europe et Monde [Key figures for the climate in France, Europe and the World]’ 2019 edition). Carbon dioxide (CO₂) is the main greenhouse gas, and is released, for example, through gaseous effluents, such as industrial gaseous effluents, especially when fossil fuels are burned to provide electricity and heat. These industrial processes include, for example, fossil fuel-based power plants, steel-making plants, biomass-based power plants, natural gas processing plants, synthetic fuel plants, refineries, petrochemical plants, cement plants and fossil fuel-based hydrogen production plants.

Several ways have been explored to reduce these CO₂ emissions, such as more efficient use of energy, prioritising the use of alternative fuels and energy sources, and carbon capture and sequestration (CCS). Increasing energy efficiency and the transition to renewable energy will reduce CO₂ emissions, but the impact of such measures is likely to be significant only in the long term. Carbon capture and storage (CCS) is a promising technology option to reduce CO₂ emissions on a shorter time scale. Thus, according to the roadmap of the International Energy Agency, 20% of total CO₂ emissions must be eliminated by CCS by 2050.

The CCS process involves separation of CO₂ (e.g., from other compounds in the industrial effluent) followed by pressurisation, transport and sequestration or transformation. Many CO₂ capture technologies have been developed, in particular for thermal power plants or other industrial processes. Indeed, it is estimated that 50% of the world's anthropogenic carbon dioxide emissions come from the combustion of fossil fuels in power plants or other industrial processes. In addition, in some regions, for example in Europe, industries emitting large quantities of CO₂ gas are taxed and/or are required to purchase trading rights for CO₂ on the basis of their use as raw material for CO₂ gas production, which often makes these energy production methods uneconomical. Thus, the majority of current development efforts are dedicated to the removal of carbon dioxide from the gaseous effluents of industrial processes.

CO₂ capture technologies developed include post-combustion capture, pre-combustion capture, oxy-fuel combustion capture, and chemical loop combustion capture. Various carbon dioxide separation technologies can be used with these options, such as chemical absorption, physical absorption, adsorption and membrane separation. Among these, chemical absorption technology has been the subject of the most development and implementation making it a solution of choice for CO₂ capture.

The traditional method described in general studies on petroleum refining processes (Le raffinage du pétrole tome 3 procédés de transformation [Petroleum refining volume 3 transformation methods]). P. Leprince, Editions Technip 1998) is called amine treatment. This method consists of effecting the coupling (thermal and material) between two steps (or unit operations). The first step uses a chemical absorption column that selectively captures gaseous CO₂ by an acid/base chemical reaction between a liquid amine solution (or equivalent basic solution) that contacts the gas flow in countercurrent under relatively high pressure conditions. The second stage uses a so-called regeneration column in which the chemical complex between the amine function and the CO₂ formed during the first stage is decomposed by a supply of thermal energy and by adjusting the pressure to the lowest value possible. This method can be used in many other gas treatments and for many other molecules of interest. It therefore does not exclusively concern CO₂.

Unfortunately, capture by chemical absorption methods is particularly energy consuming. For example, the absorption of CO₂ by amine-based solutions is known to be very effective and selective in absorbing the CO₂ gas. However, the recovery of CO₂ from such solutions, also known as the regeneration step, is highly endothermic. As a result, this regeneration process requires additional energy consumption which results, when this energy comes from fossil fuel combustion, in additional CO₂ gas emissions or a reduction in CCS energy efficiency.

Numerous solutions have been proposed to improve the energy efficiency of CO₂ capture. Unfortunately, these optimisation efforts have shown that it is difficult to find an economical way to reduce reboiler energy requirements by more than 10% (S. Freguia et al. AlChE J., 49(7), 1676 (2003)).

In particular, many studies have focused on optimising the capture process itself, especially through optimisations making it possible to find optimal operating conditions relative to the calculated operating and investment costs. For example, strategies have been proposed for intermediate cooling of the absorption column, the implementation of a multi-pressure configuration at the regeneration column, the decompression of the liquid formed in the regeneration column to form water vapour and CO₂ or the integration of the vapour generated into the compressor system (M. Karimi, et al., Chem. Eng. Res. Des., 89(8), 1229 (2011)).

These techniques have limitations. For example, the integration of CO₂ compressor during the regeneration of the absorbent leads to an increase in investment and energy requirements and was therefore not considered to be a good configuration for the capture of CO₂ (M. Karimi, et al., Chem. Eng. Res. Des., 89(8), 1229 (2011)).

In addition, the treatment of CO₂-rich gas with an amine must comply with a constraint related to a temperature not to be exceeded at the risk of damaging the chemical absorbent. For example, when the temperatures used in the system exceed 120° C., there may be an acceleration of amine degradation.

There are therefore numerous methods for capturing a molecule of interest including the use of a chemical absorbent and the regeneration of this chemical absorbent loaded with the molecule of interest. However, the costs associated with regeneration processes are too high. There is therefore a need for new methods and systems for capturing a molecule of interest, such as CO₂, from gaseous effluent having reduced costs associated with the regeneration process, without major modification of the industrial process already in place.

### Technical Problem

The objective of the invention is to remedy the disadvantages of the prior art. In particular, the objective of the invention is to propose a method for capturing a molecule of interest which consumes less thermal energy than the methods described in the prior art and which, in particular, has a reduced energy requirement at the reboiler of the regeneration column. Another objective of the invention is to propose a system for capturing a molecule of interest capable of implementing a method having an improved energy efficiency and having reduced design costs, especially by means of the reboiler being undersized.

### BRIEF DESCRIPTION OF THE INVENTION

To this end, the invention relates to a method for capturing a molecule of interest contained in a gaseous effluent, preferably in an industrial gaseous effluent, said method implementing:
a step of capturing the molecule of interest in the gaseous state by a chemical absorbent in the liquid state, in at least one absorption column, to generate a chemical absorbent loaded with said molecule of interest;
a step of regenerating said chemical absorbent loaded with said molecule of interest by supplying heat and solvent to dissociate the chemical absorbent from the molecule of interest, and to generate a regenerated chemical absorbent and a gas mixture comprising the solvent and the molecule of interest; and
a condensation step to form, from the gas mixture comprising the solvent and the molecule of interest, a liquid phase comprising the solvent and a gas phase enriched with the molecule of interest;
   said method being characterised in that:
the regeneration step is carried out in at least one regeneration section;
the condensation step is carried out in at least one condensation section;
and in that it comprises a step of compressing the gas mixture comprising the solvent and the molecule of interest upstream of the at least one condensation section so that the pressure in the at least one condensation section is higher by at least two bar, preferentially at least 2.5 bar, and more preferentially at least three bar than the pressure in the at least one regeneration section; and
in that the method comprises a heat transfer step between the at least one condensation section and the at least one regeneration section.

As will be described below, the present invention is especially based on a significant change in the conditions and in the technology implemented for the regeneration of the chemical absorbent. Such a method makes it possible to intensify the regeneration step of the chemical absorbent. In addition, when it is applied to CO₂ capture, it allows the CO₂ compression and conditioning step to be initiated at the same time and, in some embodiments, the CO₂ compression and conditioning step to be performed completely since it has been freed of water.

This new method has the advantage of greatly reducing the heat demand to be supplied to the step of regeneration of the chemical absorbent by using the heat of the compression step via a heat transfer step. This new method allows many possibilities for arranging the regeneration and condensation sections provided that an inter-section heat transfer is carried out (for example via an inter-section heat exchanger arranged to carry out the heat transfer) and that a pressure jump of at least two bar, preferably at least three bar, is carried out between the regeneration section and the condensation section (for example via a compressor positioned before the condensation section).

The original feature of the method of the invention is to produce a gas at the top of the condensation section having a water content lower than that of the methods used in the usual regeneration columns. As a result, in addition to energy savings, the method could make it possible to reduce or eliminate the need for equipment such as pumps and system for treating cooling water of the condensation circuit, condensers at the top of the column and also, in some configurations, dehydrator and dryer downstream of the condenser.

Depending on other optional characteristics of the method, the method may optionally include one or more of the following, alone or in combination:
the molecule of interest is CO₂ and the solvent is water. Indeed, the present invention is particularly suitable for the capture of CO₂ and the subsequent conditioning benefits from the pressure jump employed;
the heat supply comprises the step of transferring heat between the at least one condensation section and the at least one regeneration section and injecting a flow of water vapour into the at least one regeneration section. During regeneration, several heat sources can be used and, in particular, the heat from the heat transfer stage. The condensation section provides heat to the regeneration section;
the pressure in the at least one condensation section is at least equal to 5 bar, preferably at least equal to 10 bar, more preferably at least equal to 15 bar. As will be shown in the examples, the pressure jump has a clear effect on the performance of the present invention;
the chemical absorbent comprises at least one compound selected from: amine, ammonia, and potassium carbonate;
the chemical absorbent comprises piperazine, preferably especially in combination with at least one amine and/or at least one potassium carbonate;
the chemical absorbent consists of a demixing solvent. Preferably, the demixing solvent is a two-phase demixing solvent. This further improves the energy efficiency of the method;
the pressure in the at least one condensation section is at least 5 bar higher than the pressure in the at least one regeneration section. As will be shown in the examples, the pressure jump has a clear effect on the performance of the present invention;
it uses several condensation sections organised in series, each being operated at a pressure higher than the pressure of the preceding condensation section. As will be shown in the examples, the pressure jump has a clear effect on the performance of the present invention;
it further comprises a step of heating the liquid formed in the at least one condensation section, said heating being carried out via microwave irradiation, solar energy or an electrical resistance.

The invention also relates to a system for capturing a molecule of interest contained in a gaseous effluent, preferably in an industrial gaseous effluent, said system for capturing a molecule of interest comprising at least one absorption column for capturing the molecule of interest by a chemical absorbent, characterised in that it further comprises:
at least one regeneration section;
at least one condensation section;
a compressor configured to maintain a pressure in the at least one condensation section that is at least two bar, preferentially at least 2.5 bar, and more preferentially at least three bar, higher than the pressure in the at least one regeneration section; and
at least one inter-section heat exchanger arranged to allow heat transfer between the at least one condensation and regeneration section.

Depending on other optional characteristics of the system, this system may optionally include one or more of the following, alone or in combination:
it further comprises a decanter positioned upstream of the at least one regeneration section. The system advantageously comprises a decanter which can be positioned, for example, upstream of a regeneration section. The use of a decanter within the system increases its energy performance;
the compressor is a shock wave compressor. A compressor capable of achieving a pressure jump higher than 4 bar, preferably higher than 5 bar and preferably higher than 6 bar will be particularly advantageous within the scope of the present invention;
the at least one regeneration and condensation section are in the form of independent columns;
the at least one regeneration and condensation section are integrated into the same column;
the regeneration and condensation sections are arranged concentrically;
it comprises at least three condensation sections;
the inter-section heat exchanger has a triply periodic minimal surface;
at least a part of the walls of the condensation and/or regeneration sections has a triply periodic minimal surface;
the at least one absorption column is arranged so as to allow capture of the molecule of interest in the gaseous state by a chemical absorbent in the liquid state to generate a chemical absorbent loaded with said molecule of interest;
the at least one regeneration section is arranged so as to allow regeneration of said chemical absorbent loaded with said molecule of interest by supplying heat and solvent to dissociate the loaded chemical absorbent from the molecule of interest, and to generate a regenerated chemical absorbent and a gas mixture comprising the solvent and the molecule of interest; and
the at least one condensation section is arranged so as to allow condensation to form, from the gas mixture comprising the solvent and the molecule of interest, a liquid phase comprising the solvent and a gas phase enriched with the molecule of interest.
It is arranged so that the molecule of interest is CO₂.

The invention also concerns an industrial plant equipped with a system for capturing a molecule of interest according to the invention.

Other advantages and characteristics of the invention will become apparent on reading the following description given by way of illustrative and non-limiting example, in reference to the attached figures:

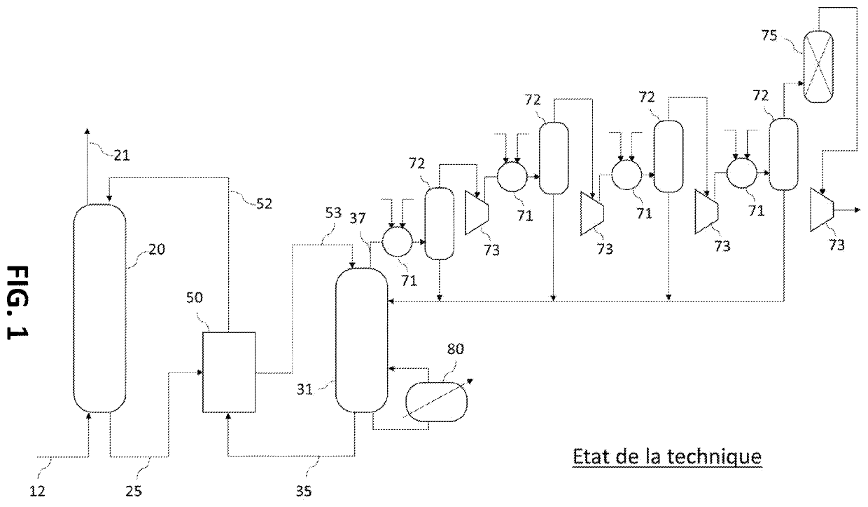

FIG. 1 provides an illustration of a CO₂ capture system according to the prior art.

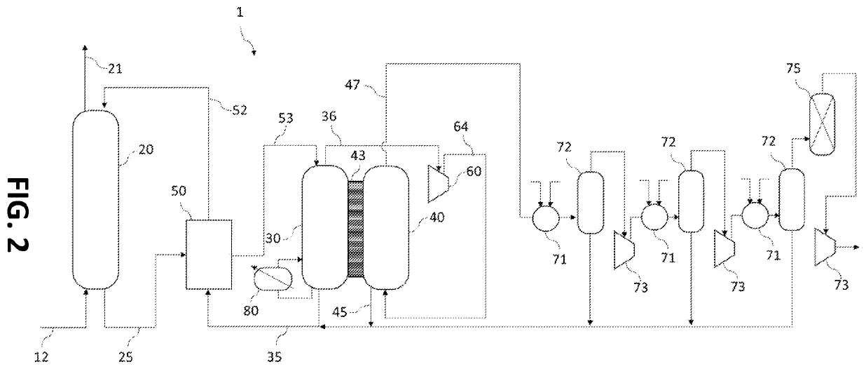

FIG. 2 provides an illustration of a CO₂ capture system according to the present invention.

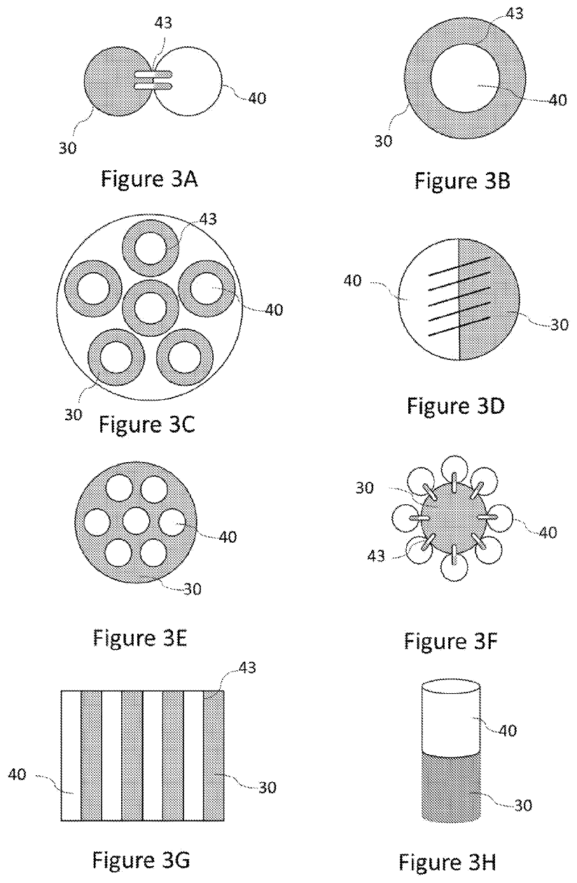

FIG. 3 show an illustration of different configurations (3A to 3H) adopted by a condensation section 40 and by a regeneration section 30.

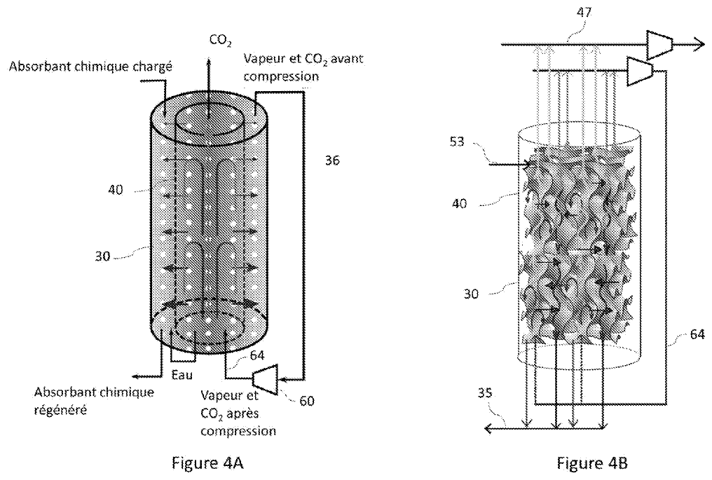

FIG. 4 provide an example of an embodiment of a CO₂ capture system according to the invention in the form of concentric columns (4A) or using triply periodic minimal surfaces (4B).

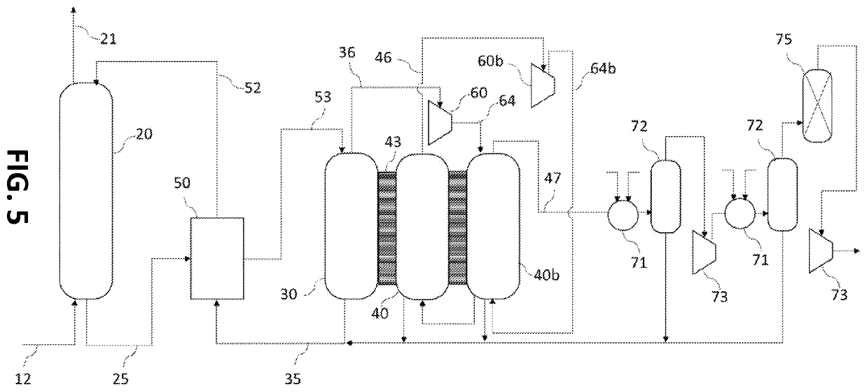

FIG. 5 provides an illustration of another CO₂ capture system according to the present invention.

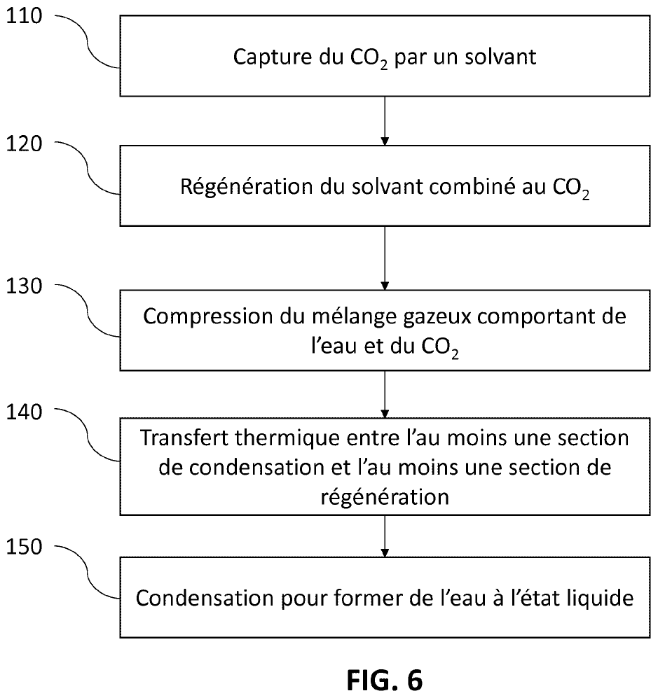

FIG. 6 provides an illustration of a CO₂ capture method according to the present invention.

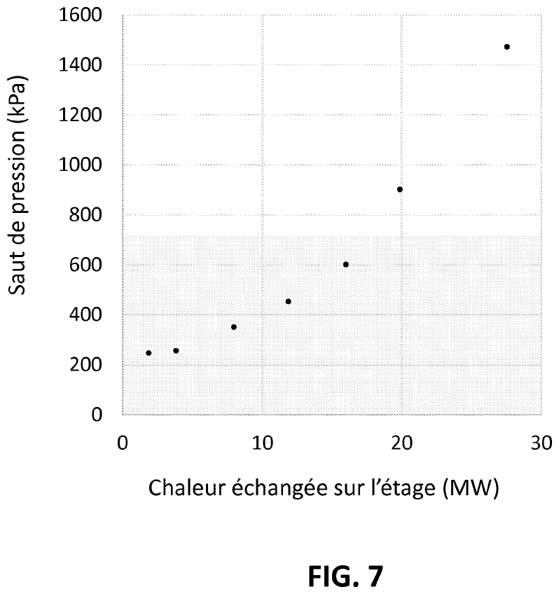

FIG. 7 provides an illustration of the heat exchanged as a function of the pressure jump applied during the implementation of a method according to the invention.

As will be appreciated, the proportion and relative scale of the elements provided in the FIGS. are intended to illustrate the embodiments of the present invention, and should not be taken in a limiting sense. As used in the figures, a ‘line’ associated with the system indicates a pipe or conduit formed of suitable material and sufficiently sized for the transport of a fluid (e.g., liquid or gas) within the line. It is understood that one or more pumps and/or compressors or other known devices for moving the fluid are also associated with the line and with the components of the integrated system discussed here. Such devices, however, are not systematically illustrated so as to allow the figures to better represent the present invention. The arrowheads represented on the ‘lines’ seen in the figures of the integrated system indicate the direction of flow of the fluid.

In addition, aspects of the present invention are described with reference to flowcharts and/or block diagrams of methods and apparatus (systems) according to embodiments of the invention. In the following detailed description of the present description, reference is made to an attached drawing, which forms part of the present description, and the way in which one or more embodiments of the invention can be put into practice is shown by way of illustration. These embodiments are described in sufficient detail to enable the person skilled in the art to put into practice the embodiments of this disclosure, and it should be understood that other embodiments may be used and process, chemical and/or structural changes may be carried out without exceeding the scope of this disclosure.

In the figures, the flowcharts and functional diagrams illustrate the architecture, functionality and operation of possible implementations of systems and methods according to various embodiments of the present invention. In this respect, each block in the flowcharts or block diagrams can represent a system, a device or a module, which is arranged to implement the specified action or actions. In some implementations, the functions associated with the blocks may appear in a different order than that shown in the figures. For example, two blocks shown in succession can, in fact, be implemented substantially simultaneously, or the blocks can sometimes be implemented in reverse order, depending on the action involved.

### DESCRIPTION OF THE INVENTION

In the remainder of the description, the expression ‘molecule of interest’ may correspond to any molecule that could damage a system or reduce the efficiency of a method or the quality of a product (e.g., H₂S, H₂O) or for environmental reasons (e.g., CO₂).

In the remainder of the description, the expression ‘chemical absorbent’ may correspond to any chemical species allowing the fixation, adsorption or absorption of atoms, molecules or ions in a gas, liquid or solid phase. In the context of the present invention, a chemical absorbent makes it possible, in particular, to retain H₂S or CO₂. As will be detailed, a chemical absorbent within the meaning of the invention may be an amine, i.e., a molecule comprising at least one amine group, but may also be a molecule comprising an ammonium group. In particular, an amine within the meaning of the invention may be an ethanolamine.

The expression ‘chemical absorbent loaded with a molecule of interest’ or ‘enriched chemical absorbent’ corresponds to a chemical absorbent combined with or associated with a molecule of interest such as H₂S or CO₂. There may be different forms of combinations. This can be a chemical bond as for amines but other forms could be considered.

The expression ‘regenerated chemical absorbent’ corresponds to a chemical absorbent that has regained its absorbent properties after use and at least partial release of CO₂.

The expression ‘gaseous effluent’, within the meaning of the invention, corresponds to a gas phase comprising a molecule of interest which it is desirable to separate from other molecules. A gaseous effluent may correspond to an anthropogenic effluent but also to natural gas.

The expression ‘industrial gaseous effluent’, within the meaning of the invention, corresponds to air contaminated by volatile organic compounds, dust, nitrous or sulphurous compounds, and, more particularly, carbon dioxide. As used here, the expression industrial gaseous effluent may correspond to any post-treatment gas containing at least one molecule of interest to be separated, such as H₂S or CO₂. Examples of industrial effluent gases or effluent gases comprise combustion gases, exhaust gases from internal combustion engines, landfill gases and/or process gases of an industrial process and containing CO₂ or another acid gas such as H₂S, such as those described herein.

The ‘multitubular system’ within the meaning of the invention corresponds to a configuration formed by one or more condensation sections and by one or more regeneration sections.

The term ‘comprises’ and its variants have no limiting meaning when these terms appear in the description and claims. In particular, where it is specified that a product comprises a particular element, it should be understood that it may also comprise several elements.

The term ‘and/or’ means one, more or all of the items listed.

In the remainder of the description, the same references are used to designate the same elements. Moreover, the various characteristics presented and/or claimed can advantageously be combined. Their presence in the description or in different dependent claims does not exclude this possibility.

As mentioned, the present invention may be considered, at least in certain aspects, as an improvement applicable to all methods of capturing molecules of interest integrating chemical absorption and regeneration. Indeed, the invention, as will be shown in the examples, allows a capture method that consumes less thermal energy than the methods described in the prior art and in particular a reduced energy requirement at the reboiler of the regeneration column.

A wide variety of technologies for capturing a molecule of interest integrating chemical absorption and regeneration have been proposed to prevent the release of CO₂ or for its capture. However, chemical absorption requires energy to regenerate the CO₂ loaded chemical absorbent. Often, the energy required to regenerate the chemical absorbent can give rise to a release of CO₂, which still impairs the overall efficiency of the capture of the CO₂ gas.

Thus, in the remainder of the description, the present invention will be detailed, in particular, for an application in which the molecule of interest is CO₂ originating from a gaseous effluent, preferably an industrial effluent. However, by means of the teaching of the present invention, the person skilled in the art could apply it to other molecules of interest originating from other effluents.

For example, referring to FIG. 1 a CO₂ capture system according to the prior art is illustrated. Such a system allows the capture of CO₂ in a gaseous effluent by means of a chemical absorbent in an absorption column 20 and the thermal regeneration of the chemical absorbent in a regeneration column 31 by using heat generated by a reboiler 80. As illustrated in FIG. 1, this system makes it possible to absorb CO₂ from a gaseous effluent 12 by using a flow of chemical absorbent 52, thus producing a flow of chemical absorbent loaded with CO₂ 25. Said flow of chemical absorbent 25 can, for example, pass through a heat exchanger 50 so as to form a hot flow of chemical absorbent loaded with CO₂ 53 before reaching the regeneration column 31. At this time, the heat is recovered between the carbon dioxide-poor absorbent 35 and the carbon dioxide-rich absorbent 25 through the heat exchanger 50.

Inside the regeneration column 31, the hot flow of chemical absorbent loaded with CO₂ 53 is heated so as to cause the release of CO₂ and the production of a hot flow of regenerated chemical absorbent 35 which is directed to the heat exchanger 50 and then the absorption column 20 in the form of a cold flow of regenerated chemical absorbent 52.

The gas flow containing the released CO₂ 37 is directed to a cooler 71, for example a water cooler, then to a water storage tank 72. While the gaseous part is directed towards a compressor 73, the liquid part is reinjected into the regeneration column 31. A series of coolers 71, water storage tank 72 and compressor 73 compresses the CO₂ and removes some of the water. The final components of a known CO₂ capture system are a dehydrator or dryer 75, such as a glycol scrubber (triethylene glycol, TEG), effective to obtain a water-free gas from a pressurised gas. The purified CO₂ passes again through a compressor 73 so as to reach the transport or storage pressure (e.g., >100 bar).

Thus, a chemical absorbent-based CO₂ capture system of the prior art combines elements for heating an effluent such as a reboiler 80 and elements for cooling an effluent such as coolers 71. In addition, it comprises numerous compressors 73 and at least one dehydrator or dryer 75. In particular, the recovered CO₂ is compressed by four compressors in series with an intermediate cooling and a condenser between two compressors.

The energy efficiency of such a system is not optimal and a great deal of research and development have been carried out to increase the energy efficiency of such a system.

In an effort to solve this problem, the present disclosure provides both a method and a system for capturing a molecule of interest from gaseous effluents that reduce energy consumption while reducing design costs.

Thus, the present invention provides an arrangement and operating principle for capturing a molecule of interest (such as CO₂) with, surprisingly, reduced energy consumption, which may present reductions of more than 30% compared with a conventional process and drying of the CO₂ flow.

Conventionally, such a system comprises the capture of a molecule of interest in a gaseous effluent by means of a chemical absorbent in an absorption column 20. Moreover, in the context of the invention, the thermal regeneration of the chemical absorbent especially uses at least one regeneration section 30 and at least one condensation section 40.

Moreover, the invention comprises a compression of the molecule of interest released by the at least one regeneration section which is reinjected into the at least one condensation section, preferably at the bottom of the section, said condensation section being arranged to allow heat transfer to the regeneration column.

FIG. 2 diagrammatically shows, in particular, a CO₂ capture system according to the invention according to a first embodiment. Such a system is particularly suitable for capturing CO₂ in a gaseous effluent, preferably an industrial gaseous effluent. Preferably, and as will be detailed below, the system according to the invention is advantageously suitable for the capture of CO₂ from industrial power plant fumes.

As illustrated in FIG. 2, the CO₂ capture system according to the invention comprises at least one absorption column 20. The system may comprise several absorption columns 20 or else absorption columns 20 with several stages. Conventionally, an absorption column 20 which can be used in the context of the invention is preferably metal. It may have a diameter of between 0.5 and 10 meters. In addition, it may have a height of between 5 and 150 meters. Nevertheless, preferably, the CO₂ capture system according to the invention comprises a single absorption column 20.

The absorption column or columns 20 are arranged to allow the capture of CO₂ by a chemical absorbent. It generally comprises one or more inlets, preferably at the bottom of the column, for a gaseous effluent 12 loaded with CO₂, such as, especially, an industrial gaseous effluent.

It also comprises one or more inlets for a flow of chemical absorbent, preferably at the top of the column. When two flows of chemical absorbent enter the absorption column 20, a first can be positioned at the top of the column and a second in the lower half of the absorption column 20.

The absorption column also comprises one or more outlets for a flow of chemical absorbent 25 enriched in CO₂, preferably at the bottom of the column. When two flows of enriched chemical absorbent leave the absorption column 20, a first can be positioned at the bottom of the column and a second in the upper half of the absorption column 20.

The absorption column also comprises one or more outlets for a gaseous effluent 21 depleted of CO₂. This outlet for the CO₂-depleted gaseous effluent 21 is preferably positioned at the top of the column. In addition, the system may comprise devices for treating this CO₂-depleted gaseous effluent 21 not shown in the figures, such as devices for washing with water or for capturing any toxic compounds or compounds of interest of the CO₂-depleted gaseous effluent 21.

As has been mentioned, a system 1 according to the invention is particularly suitable for the capture of CO₂ by a chemical absorbent.

Many chemical solvents can be used to capture a molecule of interest and more particularly CO₂ by chemical absorption. Preferably, the chemical absorbent is a chemical compound with a basic character. In fact, a chemical absorbent of basic character, that is to say comprising at least one basic function, will be capable of binding an acid molecule of interest, such as H₂S or CO₂, by formation of an acid/base bond. The chemical absorbent may, for example, comprise an amine function or a mixture of amine functions, ammonia, and/or a carbonate function.

The amines, or chemical absorbent carrying an amine function which can be used in the context of the present invention are especially primary amines (e.g., monoethanolamine (MEA) or diglycolamine (DGA) or 2-amino-2-methyl-1-propanol (AMP), secondary amines (e.g., diethanolamine (DEA) or diisopropyl amine (DIPA), tertiary amines (e.g., triethanolamine (TEA) or methyldiethanolamine (MDEA) or sterically hindered amines (e.g., 2-amino-2-hydroxymethyl-1,3-propanediol (AHPD)).

As detailed in the examples, the performance of the present invention has been illustrated for the capture of CO₂ by chemical absorption with monoethanolamine (MEA). In particular, CO₂ from the gaseous effluent can be absorbed in a solution comprising MEA and water. MEA reacts with CO₂ to form amine protonate, bicarbonate, and carbamate. Due to the high reaction enthalpy, amines generally absorb CO₂ at rapid rates.

The chemical absorbent may contain ammonia and, in particular, ammonium carbonate.

The chemical absorbent may include potassium carbonate. An aqueous solution of potassium carbonate can be used both for the capture of carbon dioxide after combustion or in pre-combustion.

Moreover, the chemical absorbent according to the invention may comprise several compounds. For example, it may comprise piperazine, especially in combination with an amine or a potassium carbonate.

More generally, it may comprise at least two mixed amines (e.g., AMP+MEA) or one or more amines with potassium carbonate.

In order to limit the energy consumption necessary for the capture of CO₂ by a chemical solvent, a chemical absorbent according to the invention may consist of a two-phase or demixing solvent. Such a two-phase demixing solvent preferably comprises two phases, for which one of the two phases is used to concentrate the captured CO₂. Thus, in particular, the chemical absorbent exhibits a separation of liquid-liquid phases which is a function of the temperature and which facilitates the release of the molecule of interest (such as CO₂) and the regeneration of the absorbent. Preferably, the chemical absorbent has a homogeneous phase at room temperature (for example below 30° C.) and a liquid-liquid phase separation at a temperature above 60° C.

More preferably, such a demixing solvent has the property of forming two immiscible liquid phases by absorption of CO₂ under specific conditions of CO₂ loading rate and/or temperature. Since the CO₂ is concentrated in a liquid phase, only a fraction of the solvent must be sent to the regeneration section 30. The result is a decrease in the liquid flow to be regenerated. Thus, only the lower phase, rich in CO₂, must be sent to the regeneration section 30. The upper phase poor in CO₂ is returned directly to the top of absorption column 20 without specific treatment. For this purpose, a decanter can be positioned at the outlet of the absorption column 20, preferably at the outlet of the heat exchanger 50 described below, the increase in temperature favouring demixing.

The use of a demixing solvent makes it possible to reduce the volume to be treated during regeneration step 120 of the solvent or chemical absorbent loaded with CO₂; this step is well known for being particularly energy-intensive and representing up to 70% of the costs of the entire gaseous effluent treatment chain. The use of such a solvent, known as a demixer, advantageously has a degradation rate, such as, for example, a loss of amine, of around 10% at a temperature of between 150° C. and 180° C. and at a pressure of 20 bar. Moreover, such a pressure advantageously makes it possible to facilitate the transport of the CO₂ once the regeneration step 120 has been implemented.

A two-phase demixing solvent may, for example, comprise one or more amine functions, one or more piperidine groups, or even be formed from several different molecules.

As illustrated in FIG. 2, the system according to the invention may comprise a heat exchanger 50 arranged so as to allow heat exchange between the regenerated chemical absorbent 35 and the enriched chemical absorbent 25. In particular, it is arranged to allow heat exchange from the regenerated chemical absorbent coming from the regeneration section 30 and the enriched chemical absorbent coming from the absorption column 20.

A flow of hot regenerated chemical absorbent 35 coming from the regeneration section 30 provides calories to a flow 25 of enriched chemical absorbent coming from the absorption column 20. Given that the release of CO₂ by the enriched chemical absorbent is very endothermic, this makes it possible to improve the energy balance of the system by proposing a hot flow of chemical absorbent enriched with CO₂ 53 as soon as it enters the regeneration section 30. Conversely, CO₂ capture is more efficient at low temperature and such a heat exchanger 50 allows a cooled regenerated chemical absorbent flow 52 at the inlet of the absorption column. These steps are endothermic for two reasons: chemical, because the chemical bond between the weak acid CO₂ and an ethanolamine is an acid-base bond and therefore strong, and thermodynamic, because of the amount of water present in the liquid entering the regeneration column.

Such a heat exchanger 50 may take the form of a shell-and-tube heat exchanger, a plate-and-frame heat exchanger, a plate-fin heat exchanger or a microchannel heat exchanger. Shell-and-tube heat exchangers consist of a shell with tubes inside; plate-and-frame heat exchangers consist of a series of corrugated plates supported by a rigid frame; plate heat exchangers consist of side bars, fins and separator sheets; microchannel or printed circuit heat exchangers consist of stacked plates with fine grooves etched into each plate. Alternatively, the heat exchanger 60 may have a triply periodic minimal surface.

Moreover, as illustrated in FIG. 2, the system according to the invention comprises at least one regeneration section 30 and at least one condensation section 40. Such names are conventionally used to denote distillation columns. Nevertheless, these column sections may also correspond to several separate columns connected to one another and, as will be detailed below, to arrangements of the heat exchanger type.

A regeneration section 30 according to the invention preferably corresponds to a zone of the system arranged to allow regeneration of the chemical absorbent, i.e., more precisely, the release or passage to the gaseous state of at least a part of the CO₂ that was previously combined with the chemical absorbent. A particular feature of the system 1 according to the invention is that it makes it possible to break a chemical bond between the chemical absorbent and the CO₂ when this requires a large supply of energy. Preferably, the CO₂ capture system according to the invention comprises a single regeneration section 30.

A condensation section 40 according to the invention preferably corresponds to a zone of the system arranged to allow condensation of water while maintaining the CO₂ in the gaseous state. That is to say, more precisely, the passage to the liquid state of at least part of the water associated with the CO₂ which has been released at the regeneration section 30. Preferably, the CO₂ capture system according to the invention comprises several condensation sections 40.

Moreover, the at least one condensation section 40 and the at least one regeneration section 30 are associated in such a way that a material transfer is possible simultaneously with the heat transfer. The system then improves heat exchange while maintaining material transfer performance. The material transfer performance makes it possible to efficiently separate the CO₂ and vapour mixture from the regenerated chemical absorbent in the regeneration section and to efficiently separate the CO₂ and water in the condensation section.

In particular, the at least one condensation section 40 and the at least one regeneration section 30 are arranged so that each of the fluids circulating in said sections is both in liquid phase and in gas phase, the liquid phase flowing in a direction opposite to the gas phase.

Preferably, the at least one regeneration section 30 and at least one condensation section 40 form an assembly of the heat integrated distillation column (HIDiC) type. In HIDiC type assemblies, a column is split into two columns: a depletion column and an enrichment column. Numerous designs for heat integrated distillation columns, called HIDiC columns, have been proposed for decades. One of the characteristics of an HIDiC column is that heat is transferred from a hot enrichment zone to a cooler depletion zone. In order to observe this situation, the enrichment zone is set to a higher pressure than the depletion zone. Nevertheless, in the current use of HIDiC type assemblies, the pressure jump to be performed is kept at a low level, otherwise the cost of recompression would become comparable to the cost of reboiling the bottom of the column 31. Thus, generally, the pressure jump in a HIDiC column is less than 2 bar, preferably less than one bar.

Thus, although the regeneration section 30 and the condensation section 40 have similarities with HIDiC columns. However, in the context of the present invention, it is essential that, contrary to the case of distillation columns of the HIDiC type, the pressure in at least one condensation section 40 is at least 1 bar higher, preferentially at least 2 bar, more preferentially at least 3 bar, even more preferentially at least five bar higher than the pressure in the at least one regeneration section 30. Thus, as shown in the examples, a conventional HIDiC type column for CO₂ capture as applied for distillation operations would not have the same performance as the present invention.

As illustrated in FIGS. 2 and 3, a system 1 according to the present invention also comprises at least one inter-section heat exchanger 43.

An inter-section heat exchanger 43 usable in the context of the present invention is advantageously a device arranged to allow heat transfer between the at least one condensation section 40 and the at least one regeneration section 30. More particularly, the heat transfer is carried out from a fluid passing through the at least one condensation section 40 to a fluid passing through the at least one regeneration section 30.

Thus, these sections operate according to a diabatic mechanism, i.e., under heat exchange control, between at least one condensation section 40 physically separated from at least one regeneration section 30.

An inter-section heat exchanger 43 which can be used in the context of the present invention may, for example, correspond to one or more common walls between a regeneration section and a condensation section, a tube heat exchanger, a shell-and-tube heat exchanger, a plate-and-frame heat exchanger, a plate-fin heat exchanger or a microchannel heat exchanger.

In addition, an inter-section heat exchanger 43 which can be used in the context of the present invention may take the form of a wall between the condensation section 40 and the regeneration section 30 combined with a packing which can be positioned on the side of the condensation section 40 and/or on the side of the regeneration section 30.

Thus, the condensation section 40 and the regeneration section 30 may each comprise a packing and this packing may be different according to the sections. The packings of the condensation section 40 and the regeneration section 30 may be fixed to a common wall between these two sections.

In particular, the packing may take the form of a thermally conductive alveolar three-dimensional structure. The packing may especially define a plurality of cells in communication with one another. The packing may have a stochastic structure or a regular structure. Thus, the arrangement of the cells may be regular or stochastic. The cells may be cylindrical, prismatic or parallelepipedal, for example. In particular, the packing may comprise Kelvin cells.

The packing may comprise or be constituted by a conductive foam, especially a foam constituted by a heat conductive material. For example, the foam may be a metal foam (e.g., copper, titanium, stainless steel or aluminium foam, or alloys thereof) or a silicon carbide foam.

The packing, as already mentioned, may be integrated both inside column 30 and inside column 40. The packing may have a surface area to volume of between 100 and 100,000 m²/m³. Preferably, the packing may have a surface area to volume greater than 1000 m²/m³, more preferably a surface area to volume greater than 10,000 m²/m³. Moreover, it may have a void ratio of between 85% and 99%. The packing can be manufactured by casting or by additive technology.

Advantageously, in one embodiment, the inter-section heat exchanger 43 may correspond, for example, to one or more common walls between a regeneration section and a condensation section. In particular, for this embodiment, the inter-section heat exchanger 43 will advantageously have a triply periodic minimal surface (TPMS).

A TPMS is defined as a surface of zero mean curvature, which means that the sum of the principal curvatures at each point is zero. Thus, a TPMS is a surface that minimises its surface with a fixed limit curve. Conventional examples of TPMS include the Schwarz surface, the gyroid surface and the diamond surface.

Advantageously, the inter-section heat exchanger 43 will comprise one or more TPMS dividing a three-dimensional domain (3D) into two separate but interpenetrating channels. This makes it possible to provide a large surface area to volume ratio.

Advantageously, the inter-section heat exchanger 43 will comprise one or more walls having a zero mean curvature at any point. Moreover, each separate channel may advantageously be interconnected in all directions. Therefore, the flow is free to move in any direction and the hydrodynamic resistance and pressure drop in the intersection heat exchanger 43 are limited.

The inter-section heat exchanger 43 can be manufactured by additive manufacturing as a complete part without welding or brazing.

The inter-section heat exchanger 43 may have a triply periodic minimal surface (TPMS) in other embodiments.

Advantageously, a condensation section 40 may be associated with a regeneration section 30 in the form of a one-piece assembly. Thus, the at least one condensation section 40 and the at least one regeneration section 30 can be arranged in the form of a one-piece integral assembly.

The one-piece assembly will comprise at least one condensation section 40 inseparable from a regeneration section 30. Moreover, it may include the inter-section heat exchanger 43.

A one-piece, preferably integral, assembly makes heat transfer more efficient. For example, in the presence of a packing established in continuity with the thermally conductive wall or walls, energy is more easily transferred from one section to another.

The one-piece assembly may be manufactured by additive manufacturing, brazing or welding of elemental metal plates or by one-piece casting.

FIG. 3 illustrate some embodiments illustrating the diversity of configuration that can be adopted by at least one condensation section 40 and at least one regeneration section 30, possibly in combination with the inter-section heat exchanger 43.

The at least one regeneration section 30 and condensation section 40 may, for example, take the form of independent columns.

As shown in FIG. 3A, the sections may be arranged parallel to each other and directly joined together. The inter-section heat exchanger 43 is then considered to be the wall or walls separating the contents of the two sections.

Alternatively, the sections or columns may not be joined together but separated by an inter-section heat exchanger 43 for fluid management allowing heat to be transferred from a condensation section 40 to a regeneration section 30. For example, a regeneration section 30 may be coupled to a condensation section 40 by a network of heat exchangers of the fluid exchanger type, the fluid possibly being the fluid flowing through the condensation section 40. A heating fluid circulates in the exchanger network; it captures the heat from the condensation section and supplies it to the regeneration section.

In one embodiment, the regeneration section 30 and condensation section 40 are arranged concentrically. In particular, as illustrated in FIG. 3B, the sections can form concentric columns, one inside the other. In such a configuration, the regeneration section 30 surrounds the condensation section 40. The system 1 according to the invention advantageously comprises regeneration 30 section(s) and condensation section(s) 40 arranged in the form of one or more concentric columns. This minimises heat losses since heat transfer takes place from the inner column (condensation) to the outer column (regeneration).

The exchange surface and therefore the inter-section heat exchanger 43 can be limited to the wall between the two columns. Nevertheless, advantageously, the sections include fins or a packing to improve the heat transfer between the two sections. The packing or fins of the outer section (regeneration) are connected to the inner section (condensation) so that the vapour of the inner section can flow in contact with the packing or fins and condense there, and the liquid then falls into the inner section. The heat released during condensation of the vapour of the inner section releases the CO₂ associated with the chemical absorbent of the outer section circulating on the packing or fins. Internal surfaces will not necessarily have the same geometry and will be conceptualised in such a way that changes in fluid flow rates on either side of the walls are taken into account. This equipment and these internal walls can be manufactured by existing casting methods or by additive manufacturing.

In particular, in the context of a concentric column arrangement, a first packing can fill the inside of the condensation section 40 and a second packing can follow the contour of the wall surrounding the condensation section 40 and extend radially into the regeneration section.

Such a system operating on the same principle could be envisaged with several tubular columns distributed homogeneously so as to maximise heat exchanges.

As illustrated in FIG. 3C, the condensation or regeneration sections can form a multitubular assembly comprising a plurality of concentric columns. In this embodiment, each section can be an independent column and all columns are positioned within an external shell.

As shown in FIG. 3D, the sections can each form one half of a dividing-wall column. In this embodiment, the system may comprise a column with two semicylindrical sections in which the heat transfer is carried out by heat transfer fluids transported through the wall and the plates of the condensation section 40 or by a packing allowing the heat transfer from a condensation section 40 to a regeneration section 30.

As illustrated in FIG. 3E, the condensation sections 40 or regeneration section 30 can each form a multitubular assembly in which the condensation sections 40 are integrated into a regeneration section 30.

As illustrated in FIG. 3F, the condensation or regeneration sections can each form a multitubular assembly in which the condensation sections 40 surround at least one regeneration section 30.

As illustrated in FIG. 3G, the condensation or regeneration sections can each form a plate exchanger type assembly in which the condensation sections 40 and the regeneration sections 30 alternate. In another embodiment, certain sections, for example, condensation sections, may be in direct contact with each other. In particular, the condensation or regeneration sections may comprise a set of finned plates, forming alternating vertical and adjacent channels to ensure the transfer of heat from the condensation section 40 to the regeneration section 30. Advantageously, the space between the vertical plates may be equipped with a packing or the walls between the plates form fins or a packing capable of improving heat transfer.

In one embodiment, the at least one regeneration section 30 and condensation section 40 may be integrated into the same column. As illustrated in FIG. 3H, the condensation section 40 and regeneration section 30 can be stacked and possibly constitute different zones of the same column. In particular, the two sections, condensation 40 and regeneration 30 can be separated by a heat exchanger where the compressed top vapours of the condensation section 40 transfer their heat to the reboiler of the regeneration section. The heat exchangers may be placed on the sides of the column so as to allow a desired combination of interstage exchanges to be selected.

In addition, as illustrated in FIG. 4B, the condensation section 40 and/or regeneration section 30 may be formed by the arrangement of walls having a TPMS-type surface. Thus, the condensation section 40 and the regeneration section 30 are integrated into a single assembly that can be manufactured by additive manufacturing.

Thus, the system according to the invention can comprise regeneration and condensation sections arranged in the form of a column comprising a packing, in the form of a set of internal assemblies with periodic structure (of the TPMS-gyroid type) allowing an increased exchange surface but without contact between the phases on either side of the jackets. This scheme allows intensified heat exchanges and therefore a reduction in the size of the equipment as well as a minimisation of the pressure drop of the low pressure system.

As illustrated in FIG. 2, the system 1 further comprises a compressor 60, i.e., at least one compressor 60, arranged to maintain a higher pressure in the at least one condensation section 40 than in the at least one regeneration section 30. In particular, such compression makes it possible to maintain a temperature downstream 64 of the compressor, for example, greater than 200° C., preferably greater than 210° C. This makes it possible to generate a heat transfer to the rich amine at the inlet of the regeneration section 30, which results in a reduced energy demand for the reboiler 80. This provides gains on two fronts: i) the vapour demand is reduced and ii) the size of the reboiler can be reduced. By transferring heat to the regeneration section, the compressed flow of CO₂ and water vapour cools and the vapour condenses into water. The purified CO₂ 47 is collected, for example, at the top of the condensation section 40. Thus, the list of dehydration equipment (cooler and drum) is also reduced. It is then treated by a series of coolers 71, water storage tank 72 and compressor 73 to compress the CO₂ and remove part of the water.

The system according to the invention may, in addition to one or more compressors 60, comprise expansion valves, for example installed at the level of the sections, to adjust the respective pressure levels in the two sections. In particular, the condensation section(s) 40 and/or regeneration section(s) 30 may especially be equipped with one or more expansion valves configured to adjust the respective pressure levels in the two sections.

In particular, a compressor 60 and therefore a compressor assembly 60 can be arranged to maintain a pressure in the at least one condensation section 40 that is at least 1 bar, 2 bar or 3 bar higher, preferentially at least 5 bar, more preferentially at least 10 bar, even more preferentially at least 15 bar higher than the pressure in the at least one regeneration section 30. The pressure difference thus established leads to a temperature difference between a condensation section 40 and a regeneration section 30 which offers the possibility of transferring heat between the two sections via an inter-section heat exchanger 43.

The compressor 60 can be selected from any type of compressor capable of establishing a pressure differential according to a ratio of at least 1:3 between the regeneration section 30 and the condensation section 40. Advantageously, the compressor 60 can be a compressor capable of establishing a pressure differential according to a ratio of at least 1:5 between the regeneration section 30 and condensation section 40, preferably at least 1:8. The compressor 60 may, for example, be a shock wave compressor.

As illustrated in FIG. 2, the water 45 generated in the condensation section 40 can be conveyed in whole or in part, like the regenerated chemical absorbent, to the heat exchanger 50. Cooling the chemical absorbent is an effective way to reduce the required amount of circulating chemical absorbent and equipment size. Cooling the chemical absorbent may especially include intermediate cooling. For example, in the context of the present invention, the water generated in the condensation section is at very high temperature. It could also undergo intermediate cooling, in a second heat exchanger, in contact with the enriched chemical absorbent which would have already undergone a heating step in a first heat exchanger 50. Alternatively, the water 45 generated in the condensation column 40 may be conveyed in whole or in part to the top of the regeneration section 30.

As illustrated in FIG. 5, the system 1 according to the invention may comprise several compressors 60, 60b configured to increase the pressure in the at least one condensation section 40 so that the system has a pressure jump between at least one condensation section 40 and one regeneration section 30 of at least 3 bar, preferably at least 5 bar, more preferably at least 8 bar and even more preferably at least 10 bar.

In particular, a first compressor may be positioned at the outlet of a regeneration section 30 and a second compressor may be positioned at the outlet of a condensation section 40 as shown in FIG. 5. Two compressors 60, 60b have been illustrated in FIG. 5, but a capture system 1 according to the invention may comprise a chain of compressors and a condensation and/or regeneration section. The multiplication of the compressors 60, 60b will make it possible to increase the pressure jump between the at least one condensation section 40 and the at least one regeneration section 30 so as to reduce or eliminate the need for a drying unit and a reboiler.

Several compressors can also be positioned at the outlet of several regeneration sections 30 and a second compressor can be positioned at the outlet of a condensation section 40 as shown in FIG. 5. The flow of vapour and CO₂ compressed by the second compressor 60b can be routed to a second condensation section 40b. It is then treated by a series of coolers 71, water storage tank 72 and compressor 73 to compress the CO₂ and remove part of the water.

Advantageously, the system will comprise a plurality of compressors 60, 60b, making it possible, for example through several successive compressions, to reach a pressure of at least 3 bar, preferentially at least 10 bar, more preferentially at least 30 bar, and even more preferentially at least 100 bar for the gas mixture comprising CO₂ passing through a section capable of carrying out heat exchange with at least one condensation section 40 and/or at least one regeneration section 30. In this case, taking into account the high pressures in the last compression phase (for example more than 50 bar), the water content in the gas phase will be zero or almost zero. The drying unit will therefore be unnecessary, which represents a significant capital gain.

The system 1 according to the invention is particularly suitable for its installation on industrial plants producing a gaseous effluent comprising CO₂. Indeed, it will be able to enable CO₂ capture and storage with improved energy efficiency.

Thus, according to another aspect, the invention also relates to an industrial plant producing a gaseous effluent comprising CO₂ and equipped with a CO₂ capture system 1 according to the invention.

For example, the industrial power plant may be a fossil fuel-based energy plant, a steel-making plant, a biomass-based energy plant, a natural gas processing plant, a synthetic-fuel plant, a refinery, a petrochemical production plant, a cement plant, or a fossil fuel-based hydrogen production plant.

According to another aspect, the invention also relates to a method 100 for capturing a molecule of interest contained in a gaseous effluent, preferably an industrial gaseous effluent. Such a method for capturing a molecule of interest can implement a system 1 for capturing a molecule of interest according to the invention or any other suitable system. In particular, the invention relates to a method 100 for capturing CO₂ contained in an industrial gaseous effluent which can be used in a CO₂ capture system 1 according to the invention or any other suitable system. As previously, a method according to the invention will be illustrated in the context of a capture of CO₂.

As illustrated in FIG. 6, conventionally, a CO₂ capture method 100 uses:
a CO₂ capture step 110 by a chemical absorbent in at least one absorption column 20 to generate a chemical absorbent loaded with CO₂,
a step 120 of regenerating said chemical absorbent loaded with CO₂ by a flow of water vapour making it possible to generate a regenerated chemical absorbent and a gas mixture comprising water and CO₂, and
a condensation step 150 to form water in the liquid state and a gas mixture enriched in CO₂.

During the CO₂ capture step 110, industrial gaseous effluents containing carbon dioxide are introduced into the lower part of an absorption column 20, and the chemical absorbent is introduced from the upper part of the absorption column 20. The gaseous effluent and the chemical absorbent therefore flow counter-currently to each other in the absorption column 20. As it comes into contact with the liquid chemical absorbent, carbon dioxide is absorbed by the chemical absorbent. The exhaust gas from which the carbon dioxide has been removed is evacuated towards the upper part of the absorption tower 10, and a chemical absorbent rich in carbon dioxide is evacuated towards a regeneration section 30 or a heat exchanger 50.

Following the regeneration step 120, the method may comprise a step of heating the liquid formed in the at least one regeneration section 30. This heating is carried out by a conventional reboiler 80, via microwave irradiation, solar energy or an electrical resistance.

As has already been mentioned, the CO₂ capture method 100 according to the invention has the particular feature of using at least one regeneration section 30 and at least one condensation section 40. In particular, in the context of a method according to the invention, the regeneration step 120 is implemented in at least one regeneration section 30. The condensation step 150 is implemented in at least one condensation section 40.

The regeneration section 30 may have a temperature at the top of the column preferably comprised between 60° C. and 150° C.

A condensation section 40 may have a temperature at the top of the column at least equal to 90° C., preferably at least equal to 100° C. In the case of several condensation sections 40, the sections may have different operating temperatures.

In addition, the method according to the invention comprises a step 130 of compressing the gas mixture comprising a solvent and a molecule of interest (e.g., water and CO₂) upstream of the condensation section 40. This compression step 130 can be carried out by any compressor and possibly by a combination of compressors (i.e., the compression step then comprising successive compression).

Such a compression step is advantageously carried out so that the pressure in the at least one condensation section 40 is at least 2 bar higher than the pressure in the at least one regeneration section 30. As has been mentioned, the pressure jumps are usually smaller and they do not make it possible to achieve the performances obtained with the present invention. Preferably, the compression step 130 makes it possible to create a pressure jump between the at least one regeneration section 30 and the at least one condensation section 40 at least equal to 2.5 bar, preferably at least equal to 3 bar, more preferably at least equal to 5 bar and even more preferably at least equal to 8 bar. This recompression of the gas mixture makes it possible, in the context of diabatic operation, to significantly improve the energy efficiency and, in particular, to reduce the energy input to the reboiler 80. Moreover, by integrating directly into the regeneration step a part of the recompression that normally takes place exclusively downstream of this step, a simplification takes place (fewer steps for the same result).

Following the step 130 of compressing the gas mixture comprising water and CO₂, the pressure in the at least one condensation section 40 is at least equal to 3 bar, preferably at least equal to 10 bar, more preferably at least equal to 15 bar, and even more preferably at least equal to 30 bar.

As illustrated in FIG. 7, in a system and a method according to the present invention, the greater the pressure jump, the greater the heat exchanged between the condensation section and the regeneration section.

In particular, a method implemented according to the present invention could, in the presence of a pressure jump of 15 bar, require an energy consumption of the reboiler of 64 MW. This is a 30% gain compared to a typical consumption of 91 MW, without taking into account the reduced need for dehydrator or dryer.

In particular, the compression step 130 may comprise the injection of the compressed gas mixture into the condensation section, preferably at the bottom of the section.

The velocity of the gas phase in the at least one regeneration section may, for example, be between 0.5 m/s and 5 m/s, preferably between 1 m/s and 3 m/s.

The velocity of the gas phase in the at least one condensation section may, for example, be between 0.5 m/s and 5 m/s, preferably between 1 m/s and 3 m/s.

Such a method allows moderate recompression of the vapour (from the regeneration section to the condensation section) and diabatic operation of all or some of the columns (heat going from the condensation section 40 to the regeneration section 30).

As has already been said, this makes it possible to reduce the energy input to the reboiler 80 and energy gains of around 20% to 30% are expected. Moreover, by integrating directly in connection with the regeneration step a part of the recompression that normally takes place exclusively downstream of this step, a simplification of the method takes place (fewer steps for the same result). This integration makes it possible to reduce the elementary steps of the original method, which results in greater operational gains for the new configuration.

In addition, the method comprises a heat transfer step 140 between the at least one condensation section 40 and the at least one regeneration section 30. The heat transfer 140 may use different heat exchangers described above.

In particular, this step allows heat to be transferred from the at least one condensation section 40 to the at least one regeneration section 30. In other words, it allows the regeneration section 30 to be heated from the heat contained in the condensation section 40 and more particularly from the heat generated during the compression step 130.

The heat transfer step advantageously makes it possible to set up a temperature gradient within each of the regeneration and condensation sections. Given the presence of a temperature gradient within each of the regeneration and condensation sections, in each section, the fluid may be present in two states: the liquid state and the gaseous state. The liquid phase of a fluid will generally flow counter-currently to the gas phase of said fluid.

The heat transfer step can be controlled so as to induce a temperature difference of at least 3° C., preferably at least 5° C., more preferably at least 10° C. between a section inlet and a section outlet. The smaller the temperature difference between the section inlet and the section outlet, the greater the energy gain.

In particular, considering this heat transfer step 140, the gas mixture, comprising water vapour and CO₂, may, in contact with walls cooled by the heat exchange in the direction of the regeneration section 30, be divided into water passing into the liquid state in contact with the wall and into CO₂ remaining in the gaseous state. The water, in the liquid state, then trickles onto the solid surfaces while the CO₂ occupies the rest of the structure and leaves the condensation section.

Thus, the method comprises a condensation step 150 allowing the formation of water in the liquid state and a gas mixture enriched in CO₂.

Advantageously, the gas mixture enriched in CO₂ will comprise a very small quantity of water.

Table 1 below shows performances that can be achieved by means of the present invention.

TABLE 1

| Pressure differential | Estimated energy |
|---|---|
| applied | gain |
| 0 bar | 0% |
| 2 bar | 0.5% |
| 3 bar | 10% |
| 5 bar | 15% |
| 10 bar | 20% |
| 15 bar | 30% |

In addition to the energy gains, the present invention may allow better dehydration efficiency and better capture efficiency as a function of the pressure differential applied.

Thus, the present invention makes it possible, by a simplified system, to greatly reduce the heat demand to be supplied to the regeneration step of the chemical absorbent and to produce a gas at the top of the condensation section having a lower water content than the methods used in the usual regeneration columns.

As a result, in addition to energy savings, the method could make it possible to reduce or eliminate the need for equipment such as pumps and system for treating cooling water of the condensation circuit, condensers at the top of the column and also, in some configurations, dehydrator and dryer downstream of the condenser.

1. A method for capturing a molecule of interest contained in a gaseous effluent, said method comprising:
a step of capturing the molecule of interest in the gaseous state by a chemical absorbent in the liquid state, in at least one absorption column to generate a chemical absorbent loaded with said molecule of interest;
a step of regenerating, in at least one regeneration section, said chemical absorbent loaded with said molecule of interest by supplying heat and solvent to dissociate the chemical absorbent from the molecule of interest, and to generate a regenerated chemical absorbent and a gas mixture comprising the solvent and the molecule of interest;
a condensation step performed in at least one condensation section to form, from the gas mixture comprising the solvent and the molecule of interest, a liquid phase comprising the solvent and a gas phase enriched with the molecule of interest;
a step of compressing the gas mixture comprising the solvent and the molecule of interest upstream of the at least one condensation section so that a pressure in the at least one condensation section is higher by at least two bar than a pressure in the at least one regeneration section; and
a heat transfer step between the at least one condensation section and the at least one regeneration section.

2. The method for capturing a molecule of interest according to claim 1, wherein the molecule of interest is CO₂ and the solvent is water.

3. The method for capturing a molecule of interest according to claim 2, wherein the heat supply comprises the step of transferring heat between the at least one condensation section and the at least one regeneration section and injecting a flow of water vapour into the at least one regeneration section.

4. The method for capturing a molecule of interest according to claim 1, wherein the pressure in the at least one condensation section is at least equal to 5 bar.

5. The method for capturing a molecule of interest according to claim 1, wherein the chemical absorbent comprises at least one compound selected from: an amine, ammonia, and potassium carbonate.

6. The method for capturing a molecule of interest according to claim 1, wherein the chemical absorbent comprises piperazine in combination with at least one amine and/or at least one potassium carbonate.

7. The method for capturing a molecule of interest according to claim 1, wherein the chemical absorbent comprises a demixing solvent.

8. The method for capturing a molecule of interest according to claim 1, wherein the pressure in the at least one condensation section is at least 5 bar higher than the pressure in the at least one regeneration section.

9. The method for capturing a molecule of interest according to claim 1, wherein it uses several condensation sections organised in series, each being operated at a pressure higher than the pressure of the preceding condensation section.

10. The method for capturing a molecule of interest according to claim 1, further comprising a step of heating the liquid formed in the at least one condensation section via microwave irradiation, solar energy or an electrical resistance.

11. A system for capturing a molecule of interest contained in a gaseous effluent, said system comprising:
at least one absorption column for capturing the molecule of interest by a chemical absorbent;
at least one regeneration section;
at least one condensation section;
a compressor configured to maintain a pressure in the at least one condensation section that is at least two bar higher than a pressure in the at least one regeneration section; and
at least one inter-section heat exchanger arranged to facilitate heat transfer between the at least one condensation section and regeneration section.

12. The system for capturing a molecule of interest according to claim 11, further comprising a decanter positioned upstream of the at least one regeneration section.

13. The system for capturing a molecule of interest according to claim 11, wherein the compressor is a shock-wave compressor.

14. The system for capturing a molecule of interest according to claim 11, wherein the at least one regeneration section and the at least one condensation section take the form of independent columns.

15. The system for capturing a molecule of interest according to claim 11, wherein the at least one regeneration section and the at least one condensation section are integrated in the same column

16. The system for capturing a molecule of interest according to claim 11, wherein the at least one regeneration section and the at least one condensation section are arranged concentrically.

17. The system for capturing a molecule of interest according to claim 11, the at least one condensation section comprising at least three condensation sections.

18. The system for capturing a molecule of interest according to claim 11, wherein the inter-section heat exchanger has a triply periodic minimal surface.

19. The system for capturing a molecule of interest according to claim 11, wherein at least a part of walls of the at least one condensation section and/or the at least one regeneration section, have a triply periodic minimal surface.

20. The system for capturing a molecule of interest according to claim 11, wherein:
the at least one absorption column is arranged to facilitate capture of the molecule of interest in the gaseous state by a chemical absorbent in the liquid state to generate a chemical absorbent loaded with said molecule of interest;
the at least one regeneration section is arranged to facilitate regeneration of said chemical absorbent loaded with said molecule of interest by supplying heat and solvent to dissociate the loaded chemical absorbent from the molecule of interest, and to generate a regenerated chemical absorbent and a gas mixture comprising the solvent and the molecule of interest; and
the at least one condensation section is arranged to facilitate condensation to form, from the gas mixture comprising the solvent and the molecule of interest, a liquid phase comprising the solvent and a gas phase enriched with the molecule of interest.

21. The system for capturing a molecule of interest according to claim 11, wherein it is arranged so that the molecule of interest is CO₂.

22. An industrial plant equipped with the system for capturing a molecule of interest according to claim 11.
